(19) United States
(12) Patent Application Publication
(10) Pub. No.: US 2015/0351328 A1
(43) Pub. Date: Dec. 10, 2015

(54) Vertically extending mobile gardening station

(71) Applicant: Carolyn Elizabeth Leigh, Carmichael, CA (US)

(72) Inventor: Carolyn Elizabeth Leigh, Carmichael, CA (US)

(21) Appl. No.: 14/120,598

(22) Filed: Jun. 6, 2014

(51) Int. Cl. A01G 9/02

(52) U.S. Cl. CPC A01G 9/022

(57) ABSTRACT

In an embodiment of the present invention, a mobile gardening station is provided and includes a first vertical support member, a second vertical support member, the first and second vertical support members held in parallel to one another and in substantially the same elevation, a wheeled base structure affixed to the first and second support members, a top support structure affixed to the first and second support members, and a plurality of rails attachable between the first and second vertical support members, the rails arranged substantially orthogonally relative to the first and second vertical support members and equally spaced apart in pairs along a substantially vertical plane. Each rail pair supports at least one hanging planter box, the at least one planter box connected to the upper rail in a pair of rails by at least one hanging connector, and resting against the lower rail in the pair of rails.

### CROSS-REFERENCE TO RELATED DOCUMENTS

The present invention claims priority to a U.S. provisional patent application Ser. No. 61/956,395, filed on Jun. 6, 2013, entitled “Vertical Garden Cart”, disclosure of which is incorporated herein in its entirety.

### BACKGROUND OF THE INVENTION

1. Field of the Invention

The present invention is in the field of gardening utilities and pertains particularly to methods and apparatus for vertical and mobile gardening.

2. Discussion of the State of the Art

In the field of gardening, there are mobile carts that are used for storing gardening tools and transporting soil and the like to a garden location. Such carts are limited to transport of materials. There are also stationary shelves and similar structures that support plants, typically in plantar boxes, where the user may those plants anywhere on any of the supporting shelves. One limitation to these types of structures is that once loaded down with plants, they are difficult to move or to reposition. This can limit sunlight getting to the plants if the structure is initially placed in a poor angle with relationship to the sun.

Therefore, what is clearly needed is vertically extending mobile gardening station that serves as both a gardening and utility station on a mobile platform.

### SUMMARY OF THE INVENTION

In an embodiment of the present invention, a mobile gardening station is provided and includes a first vertical support member, a second vertical support member, the first and second vertical support members held in parallel to one another and in substantially the same elevation, a wheeled base structure affixed to the first and second support members, a top support structure affixed to the first and second support members, and a plurality of rails attachable between the first and second vertical support members, the rails arranged substantially orthogonally relative to the first and second vertical support members and equally spaced apart in pairs along a substantially vertical plane. Each rail pair supports at least one hanging planter box, the at least one planter box connected to the upper rail in a pair of rails by at least one hanging connector, and resting against the lower rail in the pair of rails.

In one embodiment, the wheeled base structure is a lower planter box integrated with a utility box. In this embodiment, the top support structure is an upper planter box. In one embodiment the wheeled base structure extends forward significantly past the vertical plane occupied by the rails and functions as a deadweight mechanism preventing the cart from tipping over.

### BRIEF DESCRIPTION OF THE DRAWING FIGURES

FIG. 1 is a perspective view of a vertical garden cart.

FIG. 2 is an overhead perspective view of a base portion of the vertical garden cart of FIG. 1.

FIG. 3 is an overhead view of a long planting box used in the vertical garden cart of FIG. 1.

FIG. 4 is an overhead view of a medium length planter box used in the vertical garden cart of FIG. 1.

FIG. 5 is an overhead view of a short planter box used in the vertical garden cart of FIG. 1.

FIG. 6 is a side view of the vertical garden cart of FIG. 1.

### DETAILED DESCRIPTION

The inventor provides a vertical garden cart that enables modular planter display of multiple planters with utility storage in a mobile platform. The present invention is described in enabling detail using the following examples, which may describe more than one relevant embodiment falling within the scope of the present invention.

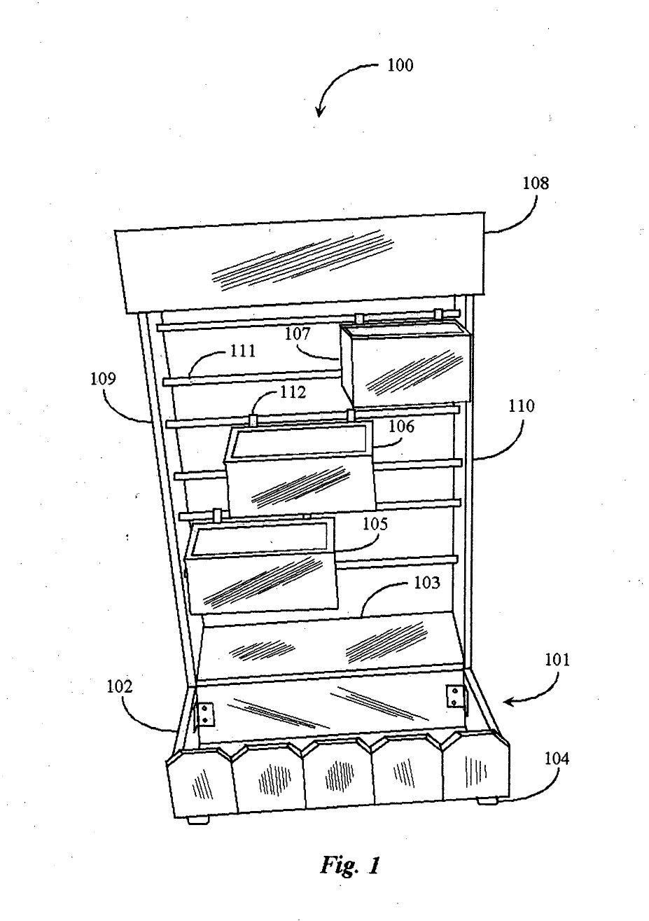

FIG. 1 is a perspective view of a vertical garden cart 100 according to an embodiment of the present invention. Vertical garden cart 100 is adapted among other things, to station multiple planter boxes in a dynamic presentation in a vertical array. In this example, a planter box 105, a planter box 106, and a planter box 107 are all supported in hanging position by a set of horizontal rails or rods such as one including rod 111, the aggregate thereof disbursed vertically in substantially equal spacing from one another and substantially aligned in a vertical plane.

Rails 111 may be solid metal rails like rebar or they may be pipes or tubes manufactured of metal or of another resilient material sufficient to support the weight of the plants without bowing or becoming unseated. In one embodiment, rails 111 are adjustable in length and may be added to or removed from garden cart 100. In one embodiment, the rails are of a fixed length and are installed when the cart is assembled and cannot be removed while the support members are in position.

The vertical garden array including planter boxes 105-107 is supported by a frame structure characterized by a first upright member 109 and a second upright member 110 forming the sides of the vertical architecture. Rails such as rail 111 may be affixed in between side members 109 and 110 by fastening them into seats on the interfacing surfaces of side members 109 and 110 at both ends.

The support frame, which may be characterized by upright members 109 and 110 and the rails, like rail 111 is further reinforced by a stationary top planter box 108. Planter box 108 forms the top of vertical garden cart 100 and is physically attached to the side members of the frame at the top ends. Planter boxes 105 through 107 are modular such that they may occupy different positions in the array and may be dynamically positioned on the fly in response to certain conditions or preferences.

The support frame is further reinforced by a base structure 101 resting on a mobile platform characterized by four castor-type wheels, such as one of four castor wheels 104 fixed to the undersurface of base 101. Base structure 101 includes a stationary base planter box 102 adjacent to a utility compartment or garden tool box 103. Planter box 102 has a decorative fence-type cover along the front face of the planter box. The footprint of base structure 101 is significantly large enough to stabilize cart 100 while fully loaded with plants preventing it form being tipped over.

In a preferred embodiment of the invention, stationary planter box 102 is set forward relative to stationary planter box 108. In this configuration, both stationary planter boxes may receive direct sunlight. Modular planter boxes 105-107 are hanging boxes adapted via hangar mechanisms 112 (two each) to be hung in dynamic arrays using horizontal rails 111. In this configuration, the spacing of the horizontal rails in substantial vertical alignment facilitates hanging and bracing of each planter box. For example, planter box 107 is hung on the top rail while the next rail down serves as a stabilizing brace for the planter box to prevent swinging and tipping.

Planter boxes 105-107 may be positioned so that each one receives direct sunlight. In the hanging position, each box may be moved laterally on the host rail (111) and is braced in hanging position by resting against the next rail down. In this example, there are six horizontal rails 111, three for hanging planter boxes and three for bracing the hung boxes. Planter boxes 105-107 may vary in shape and size or volume without departing from the spirit and scope of the invention. In this example, planter boxes 105 and 106 are the same size dimensionally. Planter box 107 is potentially smaller than boxes 105 and 106. In one embodiment, a mix of small and larger boxes, all small boxes or all large boxes might be deployed.

In use of the present invention, a user may display one or more garden plants in each of the hanging planter boxes on the vertical array. Additionally, one or more garden plants may be displayed in planter box 102 and one or more garden plants may be displayed in top planter box 108. In this configuration all displayed plants have access to direct sunlight. Moreover, garden cart 100 may be rotated periodically on its castor wheels so the plants continue to face the sun as it arcs through the sky. Utility box 103 has a top lid that is hinged to the compartment and may include a handle for easy lifting. Utility box 103 may contain gardening tools, watering accessories, garden gloves, seed and fertilizers, among other items relative to gardening.

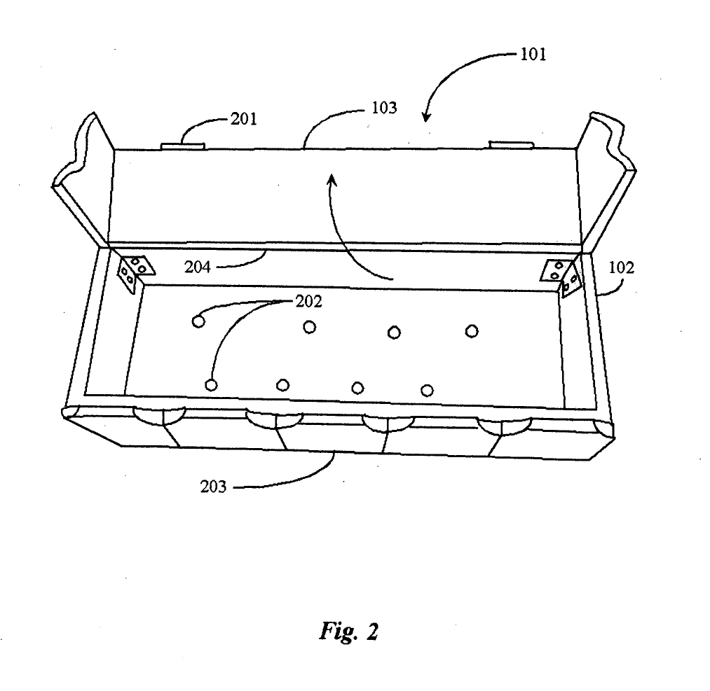

FIG. 2 is an overhead perspective view of a base structure 101 of the vertical garden cart of FIG. 1. Base structure 101 includes planter box 102 and utility box 103. Planter box 102 includes a plurality of drain openings 202 adapted to enable water to drain out of the box. In this example, a decorative siding 203 is provided and affixed, at least on the front side of box 102 for ascetic purposes.

Utility box 103 has a lid 204 fixed to the box via hinges 201. Vertical garden cart 100, including modular planter boxes 105-107 may be manufactured entirely from wood, a polymer, or some other resilient material. The depth and overall size dimension of planter boxes 105-107 may vary from box to box without departing from the spirit and scope of the present invention. There may be more or fewer drain openings 202 in planter box 102 than are illustrated in this example without departing from the spirit and scope of the invention.

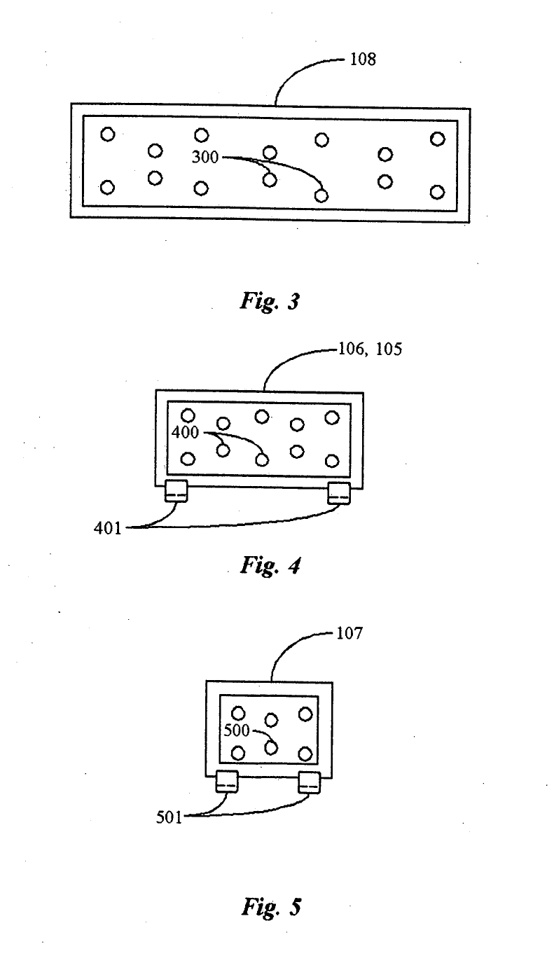

FIG. 3 is an overhead view of planting box 108 of the vertical garden cart of FIG. 1. FIG. 4 is an overhead view of a medium length planter box (105, 106) of the vertical garden cart of FIG. 1. FIG. 5 is an overhead view of a short planter box 107 of FIG. 1. Referring now to FIG. 3, top planter box 108 is adapted as a stationary box Fastened to vertical frame members (109, 110). Box 108 includes multiple drain openings 300 arranged in a pattern through the bottom of the box. Fasteners such as screws, nails, etc. may be used to secure top box 108 to the frame of the garden cart. In other embodiments, other fastening methods may be used such as glue, nut and bolt, etc.

Referring now to FIG. 4, planter box (105, 106) has hangar mechanisms 401 affixed thereto and spaced apart for hanging it on one of rails (111). Hangar mechanisms 401 may be manufactured of metal or other resilient materials sufficient to sustain the weight of the box with potting soil and plants in a hanging position of the rails. Box (105,106) includes a plurality of drain openings 400 placed through the bottom of the box.

Referring now to FIG. 5, planter box 107 includes hangar mechanisms 501 and drain openings 500 analogous to the same components described above relative to FIG. 3 and FIG. 4. Planter box 107 is a smaller box but may be of approximately the same depth as the other planter boxes. Planter boxes 105 through 107 may be manufactured of wood, a polymer, or some other resilient material without departing from the spirit and scope of the present invention.

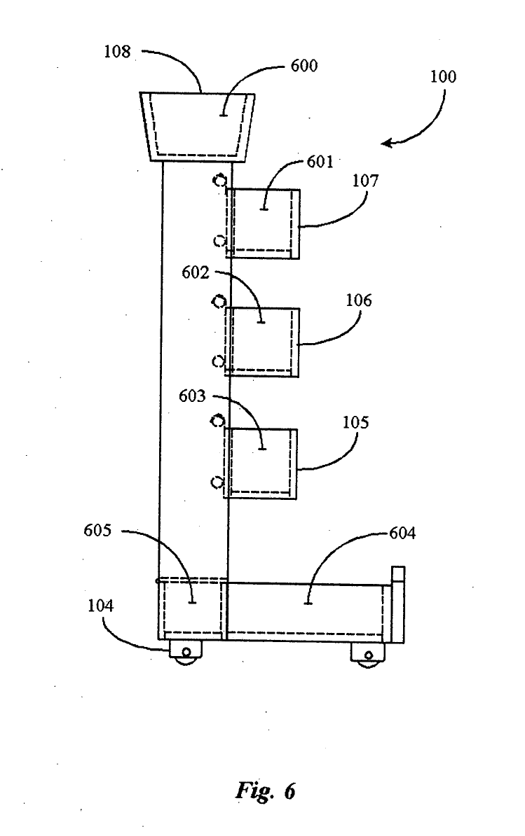

FIG. 6 is a side view of the vertical garden cart 100 of FIG. 1. Vertical garden cart 100 is designed so that the weight of potting soil in the plantar boxes is sufficiently distributed over the footprint of the base structure (101). In this view, top plantar box 108 resides directly over utility box (103). Plantar boxes 105-107 are stacked in vertical array in front of the top plantar box. Rails (111) are sufficiently aligned vertically and equally spaced vertically to accommodate the hanging positions of the hanging plantar boxes. Each hanging plantar box may be dynamically positioned or moved relative to the other boxes so that each receives direct sunlight and does not interfere with or is not usurped in any way by the other boxes on the array.

In this embodiment, there are three vertical hanging planter boxes. In other embodiments there may be more rails or fewer rails to accommodate more or fewer hanging boxes. In one embodiment, the rails may be spaced strategically so that boxes of different depths may be used in the array. The bottom stationary planter box (102) is designed to extend forward past the vertical array, in part to help distribute weight across the base structure. Castor wheels 104 may be swivel wheels that rotate 360 degrees.

In one embodiment, one or more of castor wheels 104 include break mechanisms that may be lever operated to lock the wheels in a certain position preventing them from rolling. In this example, the volumes of plantar boxes are depicted. Plantar box 108 has volume 600, box 107 has volume 601, box 106 has volume 602, box 105 has volume 603, and bottom box 102 has volume 604. Filling volume 604 with soil and plants is effective in stabilizing the entire cart against tipping over. Utility box (103) has a volume 605.

In one embodiment of the invention drip shields (not illustrated) might be employed beneath plantar box 108 and each of the hanging plantar boxes to divert water draining through the boxes so that it does not spill on the top of the utility box. In one embodiment a recycle watering system may be employed to automatically water all of the boxes and to recover the drained water for diversion or reapplication. In one embodiment of the present invention, shelves may be added in a vertical array behind the rails or in between the rails to support other potted plants, knickknacks, or other accessories.

It will be apparent to one with skill in the art that the vertical garden cart of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A mobile gardening station comprising:
a first vertical support member;
a second vertical support member, the first and second vertical support members held in parallel to one another and in substantially the same elevation;
a wheeled base structure affixed to the first and second support members;
a top support structure affixed to the first and second support members; and
a plurality of rails attachable between the first and second vertical support members, the rails arranged substantially orthogonally relative to the first and second vertical support members and equally spaced apart in pairs along a substantially vertical plane;
wherein each rail pair supports at least one hanging planter box, the at least one planter box connected to the upper rail in a pair of rails by at least one hanging connector, and resting against the lower rail in the pair of rails.

2. The mobile gardening station of claim 1 wherein the wheeled base structure is a lower planter box integrated with a utility box.

3. The mobile gardening station of claim 2 wherein the top support structure is an upper planter box.

4. The mobile gardening station of claim 1, wherein the wheeled base structure extends forward significantly past the vertical plane occupied by the rails and functions as a deadweight mechanism preventing the cart from tipping over.
